(19) United States
(12) Patent Application Publication
(10) Pub. No.: US 2021/0125796 A1
(43) Pub. Date: Apr. 29, 2021

(54) MEDIUM VOLTAGE CIRCUIT BREAKER WITH VACUUM INTERRUPTERS AND A DRIVE AND METHOD FOR OPERATING THE SAME

(71) Applicant: ABB Schweiz AG, Baden (CH)

(72) Inventors: Markus BELLUT, Duesseldorf (DE); Dietmar GENTSCH, Ratingen (DE); Philipp MASMEIER, Duesseldorf (DE); Christian REUBER, Willich (DE)

(21) Appl. No.: 17/143,178

(22) Filed: Jan. 7, 2021

Related U.S. Application Data
(63) Continuation of application No. PCT/EP2019/068624, filed on Jul. 10, 2019.

(30) Foreign Application Priority Data
Jul. 13, 2018 (EP) 18 183 548.9

(51) Int. Cl. H01H 3/28; H01H 50/42; H01H 50/46; H01H 50/18

(52) U.S. Cl. CPC H01H 3/28; H01H 50/42; H01H 50/163; H01H 50/18; H01H 50/46

(57) ABSTRACT

A medium voltage circuit breaker includes: vacuum interrupters; and a drive, the drive being provided with a magnetic actuator with a yoke, and an anchor. At least the yoke or the anchor includes a movable part, the movable part of the drive being coupled to a movable part of a switch, and the yoke being provided with an actuation coil. The actuation coil can be driven actively by activation with electrical energy. The yoke is provided with at least one passive coil, which is coupled with the actuation coil only inductively, and with at least one permanent magnet, arranged inside or at the yoke, by which magnetic flux will be further concentrated and/or enhanced towards an airgap to the anchor.

### CROSS-REFERENCE TO PRIOR APPLICATION

This application is a continuation of International Patent Application No. PCT/EP2019/068624, filed on Jul. 10, 2019, which claims priority to European Patent Application No. EP 18 183 548.9, filed on Jul. 13, 2018. The entire disclosure of both applications is hereby incorporated by reference herein.

### FIELD

The invention relates to a medium voltage circuit breaker with vacuum interrupters and a drive, and method for operating the same, wherein the drive is provided with a magnetic actuator with a yoke, and an anchor, wherein at least the yoke or the anchor is movable, and the movable part of the drive is coupled to the movable part of a switch, and that the yoke is provided with an actuation coil.

### BACKGROUND

For medium voltage circuit breaker (CB) with magnetic actuators, it is state of the art, to operate the device by applying a certain current or a current profile or a voltage that will result in a current to a coil of the actuator. Said current will create a force to drive said operation. The speed of this operation will be the result of the force of the magnetic actuator and of other factors, like masses, spring forces and friction.

Factors like spring forces and friction may differ e.g. due to manufacturing tolerances or due to temperature variations. The result will be that the speed of the operation may differ from CB to CB and also from operation to operation.

When the speed of operation is too slow, electrical arcing can damage the switching contacts, or contact welds cannot be opened. When the speed is too high, the mechanical impacts may reduce the mechanical lifetime of the CB.

Depending on the range of speed fluctuation and on the application of the CB, these differences in operation speed may be tolerable or not. In case it is not tolerable, the magnetic actuator can e.g. be fitted with a speed control, comprising speed measurement, speed controller, and adjustment means for the coil current. However, a system like that consists of many parts and is therefore relatively expensive and not fail-safe.

### SUMMARY

In an embodiment, the present invention provides a medium voltage circuit breaker, comprising: vacuum interrupters; and a drive, the drive being provided with a magnetic actuator with a yoke, and an anchor, wherein at least the yoke or the anchor comprises a movable part, the movable part of the drive is coupled to a movable part of a switch, and the yoke is provided with an actuation coil, wherein the actuation coil is configured to be driven actively by activation with electrical energy, and wherein the yoke is provided with at least one passive coil, which is coupled with the actuation coil only inductively, and with at least one permanent magnet, arranged inside or at the yoke, by which magnetic flux will be further concentrated and/or enhanced towards an airgap to the anchor.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows an example of how the windings of the present invention can be arranged;

FIG. 2 shows an example of how the windings of the present invention can be arranged;

FIG. 3 shows an example of how the windings of the present invention can be arranged; and

FIG. 4 shows an example of how the windings of the present invention can be arranged.

### DETAILED DESCRIPTION

In an embodiment, the present invention provides creates eddy currents in the actuator of the drive of an aforesaid circuit breaker (CB) in a very effective and self-regulating, but constructively easy way, so that the operating speed of said CB is limited. The faster an operation of the CB is, so stronger is the damping effect due to the eddy currents.

In an embodiment, the present invention proposes to use dedicated eddy-current windings inside the magnetic actuator to damp the operating speed in case it is too high.

In an embodiment, the present invention provides that the actuation coil is being driven actively by activation with electrical energy, and that the yoke is provided with at least one passive coil, and which is coupled with the actuation coil only inductively.

In a further advantageous embodiment, the passive coil is aligned serially inside the yoke in such, that the magnetic fieldlines inside the coils are in parallel.

In a further advantageous embodiment, the passive coil is aligned inside or outside of the active coil in such, that the magnetic fieldlines inside the coils are in parallel.

In a further advantageous embodiment, three passive coils are arranged distributed around each leg of an E-shaped yoke.

In a further advantageous embodiment, at least one passive coil is arranged as a winding in a grove of at least one leg of the E-shaped yoke.

In a further embodiment, the passive coil, or passive coils are provided with two terminals each, which are short-circuited directly, or provided with a resistor, or a diode, or a zenerdiode between the terminals of each passive coil.

According to a method for operating such a drive, like said before, the core of the invention is, that the actuation coil is being driven actively by activation with electric energy, and that the yoke is provided with at least one further passive coil, which is or are coupled with the actuation coil only inductively, so that the passive coil is, or passive coils are activated by induction of the active coils via the yoke.

The terminals of said passive coil or coils are short-circuited so that induced currents or eddy currents can flow and the speed limiting effect is enabled.

Further advantageous is, that the terminals of the passive coil or coils or some of the coils are not short-circuited, but coupled via a diode or diodes, or resistor or resistors, or zenerdiode or zenerdiodes, in such, that the amount of eddy current and so the intensity of the damping effect can be adjusted, also separately for closing and opening operations.

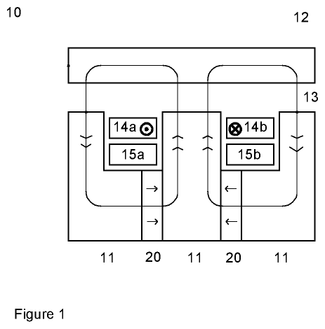

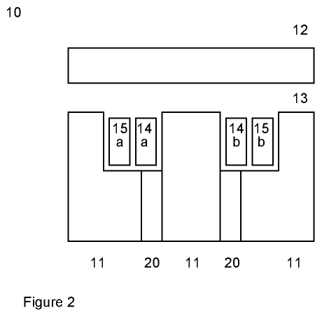

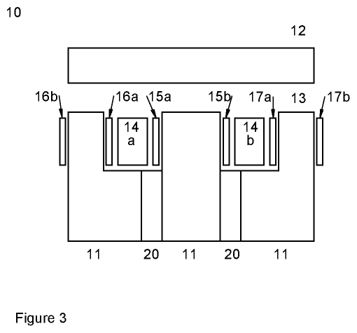

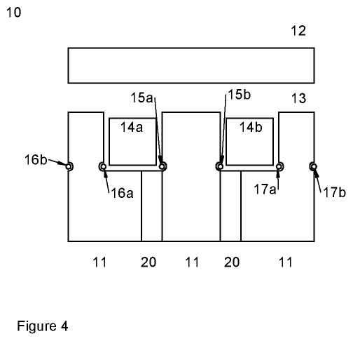

FIGS. 1 to 4 show as examples how these windings can be arranged:

The regular procedure of e.g. a circuit breaker (CB) closing operation starts in the OFF position of said CB with a certain airgap 13. When by external means a current is made to flow in the first coil 14, a magnetic flux will flow through the center of said coil, which is in the same time the center leg of the E-shaped yoke 11. When the direction of the current in the leg 14a is pointing outside the plane of the drawing, towards to the viewer, then the direction of the current in the leg 14b will be inside the plane of the drawing, away from the viewer, and the direction of the magnetic flux in the center-leg of yoke 11 will be upwards, passing the airgap 13, flowing to both sides of the anchor 12, passing again the airgap 13, flowing downwards through the lateral legs of the E-shaped yoke 11 and returning at the lower end of the yoke 11 to its center leg. Due to the magnetic flux passing the airgap, the anchor 12 is attracted to the yoke 11 and the CB will operate.

The (CB) circuit breaker is kept in the closed position e.g. by one or more permanent magnets 20 within the magnetic circuit, arranged in a way that the anchor 12 is attracted to the yoke 11, usually a fixed yoke, also without current flowing in the coils.

So that means, that with at least one permanent magnet, arranged inside or at the fixed yoke, by which the magnetic flux will be further concentrated and/or enhanced towards the airgap to the movable anchor.

When the current that is flowing in the first coil is changing, also the magnetic flux is changing. This change of magnetic flux will induce a voltage in all other coils that are magnetically coupled to the first coil. When a current can flow through said other coils, e.g. like the coils 15 to 17 with short-circuited terminals, an eddy current is flowing.

The usage of at least one permanent magnet gives an additional effect for the creation of eddy currents. The amount of magnetic flux that is originating from the permanent magnets and that is linked with the coils depends on the magnitude of the airgap 13, as the airgap represents a resistance for the magnetic flux. When the actuator is e.g. closing, the airgap 13 becomes smaller, the resistance also becomes smaller and the magnetic flux is increased. And this change of flux results in the additional eddy current effect due to the permanent magnets.

The flow of an eddy current can be controlled by the way how the terminals of the coils 15 to 17 are connected—when the terminals are open, then no eddy currents will flow. When the terminals are closed, a relatively high eddy current will flow.

When the terminals are connected with a diode, the possible direction of eddy current can be defined. When the terminals are connected with resistors, zener diodes or voltage sources, the amount of eddy current can be adjusted.

Beside a changing current in the first coil, also the motion of the anchor 12 will change the magnetic flux that is linked to the coils 14 to 17. When anchor 12 is e.g. moving towards the yoke 11, the airgap 13 becomes smaller. Therefore, the magnetic resistance in the magnetic circuit is reduced, i.e. more magnetic flux will be generated by the same source. The source can be a current in the first coil or a permanent magnet.

The change of magnetic flux due to motion will also induce voltage in all coils that are magnetically coupled the yoke 11.

The effect of eddy currents is that they are acting against their source, i.e. they are braking or damping the change of the magnetic flux.

What is considered here are eddy currents due to the motion of the anchor 12. When the anchor is moving faster, the change of flux is faster, the eddy currents are higher and also the damping effect is higher. This system is controlling itself, as the damping is increasing with the speed, so motion at a relatively high speed is strongly damped while motion at relatively low speed is weakly damped.

The eddy current effects due to the change of current are not significant for controlling the operation when the ramp-up speed is always the same, as it is the case when a standard current-controller is being used for ramping up or down the current in the first coil. The according damping effect is always the same and can be considered in the overall setup of the drive system.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

10: Magnetic actuator
11: Fixed yoke of actuator; usually made from iron; here shaped as an “E”
12: Movable anchor; usually made of iron
13: Airgap—in ON position, the airgap is virtually zero, i.e. 12 rests on 11
14a, 14b: legs of first coil
15a, 15b: legs of second coil
16a, 16b: legs of third coil
17a, 17b: legs of fourth coil
20: permanent magnet

What is claimed is:

1. A medium voltage circuit breaker, comprising:
vacuum interrupters; and
a drive, the drive being provided with a magnetic actuator with a yoke, and an anchor, wherein at least the yoke or the anchor comprises a movable part, the movable part of the drive is coupled to a movable part of a switch, and the yoke is provided with an actuation coil,
wherein the actuation coil is configured to be driven actively by activation with electrical energy, and
wherein the yoke is provided with at least one passive coil, which is coupled with the actuation coil only inductively, and with at least one permanent magnet, arranged inside or at the yoke, by which magnetic flux will be further concentrated and/or enhanced towards an airgap to the anchor.

2. The medium voltage circuit breaker according to claim 1, wherein the passive coil is aligned serially inside the yoke such that magnetive fieldlines inside the coils are in parallel.

3. The medium voltage circuit breaker according to claim 1, wherein the passive coil is aligned inside or outside of the active coil such that magnetive fieldlines inside the coils are in parallel.

4. The medium voltage circuit breaker according to claim 1, wherein the at least one passive coil comprises three passive coils, and
wherein the three passive coils are arranged distributed around each leg of an E-shaped yoke.

5. The medium voltage circuit breaker according to claim 4, wherein at least one passive coil is arranged as a winding in a groove of at least one leg of the E-shaped yoke.

6. The medium voltage circuit breaker according to claim 1, wherein each of the at least one passive coil is provided with two terminals, which are short-circuited directly, or provided with a resistor, or a diode, or a zenerdiode between the terminals thereof.

7. A method of operating a drive for low-, medium-, or high-voltage switchgear, comprising:
providing the drive with a magnetic actuator with a yoke, and an anchor, wherein at least the yoke or the anchor comprises a movable part, and the movable part of the drive is coupled to a movable part of a switch, the yoke being provided with an actuation coil;
actively driving the actuation coil by activation with electric energy;
providing the yoke with at least one further passive coil, which is or are coupled with the actuation coil only inductively, and which has or have terminals that are short-circuited, so that the at least one further passive coil is or are activated by induction of the active coils via the yoke; and
providing the yoke with at least one permanent magnet, arranged inside or at the yoke, to further concentrate and/or enhance magnetic flux towards an airgap to the anchor.

8. The method according to claim 7, wherein terminals of the passive coil or coils or some of the coils are not short-circuited, but coupled via a diode or diodes, or resistor or resistors, or zenerdiode or zenerdiodes, such that an amount of eddy current and an intensity of a damping effect are adjustable.
